(19) United States
(12) Patent Application Publication
(10) Pub. No.: US 2014/0006722 A1
(43) Pub. Date: Jan. 2, 2014

(54) MULTIPROCESSOR SYSTEM, MULTIPROCESSOR CONTROL METHOD AND PROCESSOR

(71) Applicant: Takashi HORIKAWA, Tokyo (JP)

(72) Inventor: Takashi HORIKAWA, Tokyo (JP)

(73) Assignee: NEC CORPORATION, Tokyo (JP)

(21) Appl. No.: 13/942,897

(22) Filed: Jul. 16, 2013

Related U.S. Application Data
(63) Continuation of application No. PCT/JP2011/080162, filed on Dec. 27, 2011.

(30) Foreign Application Priority Data
Jan. 18, 2011 (JP) 2011-008120

(51) Int. Cl. G06F 12/08

(52) U.S. Cl. CPC G06F 12/0808
USPC 711/145

(57) ABSTRACT

A multiprocessor system includes first through third processors and memory storing address data, all interconnected. In the first processor an access control unit receives the address and the data, and a cache memory storing a cache line including the address, the data and a validity flag. The cache memory invalidates the flag when receiving a request for invalidating the cache line. The access control unit stores the address as a monitoring target when the flag of the cache line is invalidated. When storing a first address included in an invalidated first cache line as a monitoring target, receiving a second address and second data outputted by the third processor is output in response to a request of the second processor, the access control unit judges whether the first address coincides with the second address and relates the first address to the second address to store them when true.

### TECHNICAL FIELD

The present invention relates to a multiprocessor. More particularly the present invention relates to acquisition of a right of entry to a critical section.

### BACKGROUND ART

In an information processing system configured so as to execute a plurality of threads in parallel, at any time when a certain thread is executed, execution of another thread may interrupt the execution of the certain thread. If there is no relationship between processings executed by these threads, there is no problem because the acquired result is not changed even though the interruption arises. However, when the interruption of the other thread arises during the processing of the thread, if the other thread relates to the processing executed by the thread, the acquired result might be different from that when the interruption does not arise. Thus, some kind of measures is required.

For example, it is supposed that each of two threads executes a processing of adding one (1) to an identical variable, that is, reading the variable, adding one (1) to the variable, and writing back the result. A problem occurs in the case that, during the thread reading the variable and writing back the result of adding one (1), the processing of the other thread (adding one (1) to the variable) interrupts the processing of the thread. If this interruption arises, the first executed processing writes back a value of the result of adding one (1) to an original value into the variable, without perceiving update of the variable by the interruption processing. If the interruption of the other thread processing does not arise, since the two threads respectively add one (1) to the variable, as a result, the variable increases by two (2). However, if the processing is executed in the order in which the other thread processing interruption arises during the execution of the thread processing, even though the operation is performed in which the two threads respectively add one (1) to the variable, the variable increases by one (1) only and the correct result cannot be acquired. As described above, the processing section (in the above example, the section from reading out the data to writing back the processed result) in which a problem occurs if the interruption of the other processing arises during the execution of the processing is called a critical section. In the critical section, control is explicitly performed such that the interruption of the other thread processing does not arise. Hereinafter, it is referred to as the critical section.

A case that there is a single processor executing a program will be described. In this case, during execution of a program as a thread, interruption of execution of another program (thread) may arise, because a certain event arises which causes thread switching during the execution of the first thread and an execution unit realized by cooperation between the processor and an operating system executes the thread switching. For this reason, it is effective to instruct the execution unit to be prohibited from switching to the other processing (thread). In detail, if the execution unit is instructed to be prohibited from switching to the other processing at the time of entering a critical section and to be allowed switching to the other processing at the time of going out the critical section, it is secured that the interruption of the other processing does not arise during the period.

On the other hand, in a multiprocessor system, a correct processing result cannot be secured only by prohibition of switching to another processing. The prohibition of switching to the other processing is effective only for a processor executing the program, and is not effective for another processor executing the program. As a method in which the program execution by the other processor is made not to enter the critical section, a coping method is commonly applied in which a flag (hereinafter referred to as a lock word) indicating whether or not a thread executing the critical section is prepared exists.

The processing method using the lock word is as follows.

(a1) An execution unit of a certain processor (this-processor) checks a lock word at a time when a thread enters a critical section.
(a2-1) If the lock word is “a value indicating being not in use (hereinafter referred to as unlocked)”, the execution unit changes the lock word into “a value indicating being in use (hereinafter referred to as locked)” and executes a processing of the critical section.
(a2-2) If the lock word is the locked, after the execution unit waits for a time when the lock word is changed into the unlocked, the execution unit changes the lock word into the locked and executes the processing of the critical section.
(a3) The execution unit brings the lock word back to the unlocked.

By performing the above control, the problem does not occur, the problem being that the processing executed by this-processor and the processing executed by the other processor compete against each other in the critical section.

Moreover, regarding the critical section, the critical section may be a bottleneck element which determines an upper limit of performance of the information processing system. This is because, when a certain thread executes (hereinafter referred to as “use” for adapting to other resources) the critical section, another thread necessary to use the critical section is required to wait for an exit of the thread which is using the critical section. This means that a queue is formed for the critical section as similar to physical resources such as a processor and a disk. That is, if a usage rate of the critical section approaches 100% earlier than the other resources due to a load increase, the critical section may be the bottleneck which determines the upper limit of the system performance.

The usage rate of the critical section is the product of the number of usage times per unit time and an operating time per usage. Thus, in the situation that a throughput of the processing of the information processing system is saturated and the critical section is the bottleneck (the usage rate is 100%), the relationship between the above two factors becomes the inverse proportion. The reason is considered that when the critical section becomes the bottleneck, the number of usage times per unit time comes to correspond to the throughput performance of the information processing system. In this situation, in order to increase the upper limit of the throughput performance of the information processing system, it is necessary to shorten the operating time per usage of the critical section.

The operating time per usage of the critical section is a program operating time from entering the critical section to exiting there. In detail, it is the product of (b1) the number of instructions during that time, (b2) the number of clocks per instruction (CPI: Clock Per Instruction), and (b3) the time of a clock cycle. Here, since it is not easy to reduce the (b1) and the (b3), each of them is often treated as a fixed value. The (b1) is the factor that is determined by the content of the processing executed while protected in the critical section, that is, the algorithm implemented in the program. The (b3) is the factor that is determined by the hardware of the information processing system. On the other hand, the (b2) is the factor that various elements such as the instruction execution architecture of the processor and the architecture of the cache memory are involved, and therefore there is a large room for tuning.

Next, techniques for realizing the critical section will be described. The important point for realizing the critical section is that the following two operations, which are executed at the time when the thread enters the critical section, should be treated similarly to the critical section, the first one being an operation of checking (reading) the value of the lock word and the second one being an operation of changing to (writing) the locked when the value of the lock word is the unlocked. Accordingly, in a processor having a function for multiprocessing, instructions for executing these operations are prepared. For example, in a non-patent literature 1, the cmpxchg instruction of the x86 processor of Intel Corporation is disclosed. This instruction uses three operands of a register (eax register) reserved by the instruction, a register operand and a memory operand. Incidentally, an operation that this cmpxchg operand performs is often called the Compare And Swap (CAS operation).

An operation of the CAS instruction is as follows.

(c1) An execution unit of a certain processor (this-processor) reads a value of the memory operand.
(c2-1) The value coincides with a value of the eax register, the execution unit writes a value of the register operand to a memory.
(c2-2) The value does not coincide with the value of the eax register, the execution unit writes the value to the eax register.

These sequence operation is executed atomically. Here, the “atomically” means it is ensured, by hardware operation, that another processor does not access the memory between the (c1) of the memory reading operation and the (c2-1) of the memory writing operation.

To execute the lock operation using the above CAS instruction, after preparing the situation that the unlocked is inputted into the eax register, the locked is inputted to the register operand and the memory operand is the lock word, the execution unit executes the CAS instruction. When the lock word is the unlocked, since the (c2-1) is executed, the execution unit rewrites the lock word into the locked and does not change the value of the eax register. On the other hand, when the lock word is the locked, since the (c2-2) is executed, the execution unit does not rewrite the lock word and sets the locked to the eax register. The execution unit executing the CAS instructions can check whether or not it succeeds in the lock operation by checking the value of the eax register after the execution of the CAS instruction. That is, the execution section can judge whether it is the situation for executing the critical section or it is the situation for waiting until the unlocked is set to the lock word.

As another technique for the multiprocessor system, a patent literature 1 is disclosed. The multiprocessor system is composed of a main memory device and a plurality of data processing device. Each data processing device has a buffer memory which stores a copy of the main memory for each block including an address. The data processing device has an address storage mechanism which, when a block of a buffer memory is invalidated by writing to the main memory device by another data processing device, stores an address of the invalidated block. The data processing device is characterized in that the data processing device does not stores, when accessing the main memory device, if the address of the invalidated block exists in the address storage mechanism, a copy of the invalidated block into the buffer memory. Therefore, each data processing device does not invalidate the buffer memory many times. Thus, the decrease of the effect of the multiprocessor system can be avoided.

### CITATION LIST

### Patent Literature

[PTL 1] Japanese Patent Publication JP Heisei 3-134757A

### Non Patent Literature

[NPL 1] “Intel64 and IA-32 Architectures Software Developer's Manual Volume 2A: Instruction Set Reference, A-M”, [online], Internet <URL:http://www.intel.com/Assets/PDF/manual/253666.pdf>

### SUMMARY OF INVENTION

A shared bus access executed when the CAS instruction is successful depends on a coherence protocol of a cache memory. Below, an operation of the cache of a copy back policy will be described. FIG. 1 is a view showing an initial state of a multiprocessor system. With reference to FIG. 1, the multiprocessor system includes: a plurality of processors 500 (500-1 to 500-n); and a memory 600, those being connected by a shard bus 700. Each of the plurality of processors 500 (500-1 to 500-n) includes: an instruction execution unit 510 (510-1 to 510-n) and a cache memory unit 520 (520-1 to 520-n). The cache memory unit 520 stores a plurality of cache lines. Each cache line includes: a validity flag 801 indicating that the cache line is valid or invalid; data; and an address of the data. In FIG. 1, the plurality of processors 500 (500-1 to 500-n) shares the cache line including a lock word 802 as the data. The lock word 802 indicates the unlocked or the locked, and the unlocked is indicated using diagonal lines as an initial value of the lock word 802.

A case that the processor 500-1 changes a value of the lock word 802 will be described. FIG. 2 is a view showing a state that the processor 500-1 starts changing the lock word 802. First, the processor 500-1 executes a processing that a copy of the lock word 802 included in each of the processors 500-2 to 500-n is invalidated. In detail, the instruction execution unit 510-1 of the processor 500-1 specifies the address of the lock word 802 to be invalidated and outputs an invalidation request of the corresponding cache line through the cache memory unit 520-1 to each of the processors 500-2 to 500-n. Here, an operation that a certain processor 500 specifies an address of data to be invalidated and requests invalidation of a cache line corresponding to the address is called an invalidation request in this Description.

When receiving the invalidation request from the processor 500-1, each of the processors 500-2 to 500-n changes the validity flag 801 of the corresponding cache line into the invalid to invalidate the cache line. According to this processing, the processor 500-1 is the only processor to have the valid cache line including the value of the lock word 802.

Next, the instruction execution unit 510-1 of the processor 500-1 changes the value of the lock word 802. FIG. 3 is a view showing a state that the instruction execution unit 510-1 of the processor 500-1 changes the value of the lock word 802. As a changed value of the lock word 802, the locked is indicated using vertical lines. Incidentally, since the cache uses the copy back policy, just after the value of the lock word 802 of the processor 500-1 is changed, it may be different from the value of the lock word 802 of the memory 600.

Each of the processors 500-2 to 500-n monitors own lock word 802 and executes a processing for acquiring a right of entry to the critical section. FIG. 4 is a view showing that each of the instruction execution units 510-2 to 510-n outputs an access request of each lock word 802. Each of the instruction execution units 510-2 to 510-n outputs the access request of each lock word 802. The access request of each of the instruction execution units 510-2 to 510-n is outputted through the shared bus 700 because of a cache miss of each of cache memory units 520-2 to 520-n. As a result, the plurality of the access requests outputted from the processor 500-2 to 500-n competes against each other. FIG. 4 shows that the access request of the processor 500-n is firstly outputted to the shared bus 700 and the access requests of the processors 500-2 and 500-3 are in a waiting state. For the access request to the lock word 802 by the processor 500-n, the cache memory unit storing the changed value of the lock word 802 is the cache memory unit 520 of the processor 500-1. Accordingly, the processor 500-1 provides the changed value of the lock word 802 to the processor 500-n and the memory 600. FIG. 5 is a view showing that the processor 500-1 outputs the lock word 802.

After completion of the processing for the access request of the processor 500-n, it is supposed that the access request of the processor 500-2 is outputted and the access request of the processor 500-3 is in the waiting state. FIG. 6 is a view showing a state after the processor 500-2 outputs the access request to the shared bus 700. For the access request to the lock word 802 by the processor 500-2, since the memory 600 stores the latest value, the processor 500-2 acquires the value of the lock word 802 from the memory 600. After that, the processor 500-3 executes a processing similar to the processor 500-2.

As described above, in the case that the plurality of processors 500 monitors the lock word 802 and executes the processing for acquiring the right of entry to the critical section, the access to the lock word 802 by each of the plurality of the processors 500 is executed one after the other. This means that the number of accesses through the shared bus 700 is increased and the usage rate of the shared bus 700 is increased. When the usage rate of the shared bus 700 is increased, waiting time for the access through the shared bus 700 is lengthened with respect to the other processors 500 which execute a processing different from the processing for acquiring the right of entry to the critical section. As mentioned above, in the multiprocessor system, there is a problem that, in the situation that the plurality of threads simultaneously executes the processing for acquiring the right of entry to the critical section, the usage rate of the shared bus 700 is increased which leads to deterioration of the performance of the whole system.

An object of the present invention is to provide a multiprocessor system which can suppress the deterioration of the performance even in the situation that the plurality of threads simultaneously executes the processing for acquiring the right of entry to the critical section.

A multiprocessor system of the present invention includes: a first processor; a second processor; a third processor; a main memory device configured to store data related to an address; and a shared bus configured to connect the first processor, the second processor, the third processor and the main memory device. The first processor includes: an access control unit configured to receive the address and the data through the shared bus, and a cache memory unit configured to store a cache line including the address, the data and a flag indicating valid or invalid. The cache memory unit invalidates the flag when receiving a request for invalidating the cache line through the shared bus. The access control unit stores the address as a monitoring target when the flag of the cache line is invalidated.

In the situation that the access control unit stores a first address included in an invalidated first cache line as a monitoring target, when the access control unit receives a second address and second data outputted by the third processor to the shared bus in response to a request of the second processor, the access control unit judges whether or not the first address coincides with the second address and relates the first address to the second address to store them when the first address coincides with the second address.

In a multiprocessor control method of the present invention, a multiprocessor includes: a first processor, a second processor, a third processor, a main memory device configured to store data related to an address, and a shared bus configured to connect the first processor, the second processor, the third processor and the main memory device. The first processor includes: an access control unit configured to receive the address and the data through the shared bus, a cache memory unit configured to store a cache line including the address, the data and a flag indicating valid or invalid, and an instruction executing unit configured to execute an instruction by using the data included in the cache line. The cache memory unit invalidates the flag when receiving a request for invalidating the cache line through the shared bus. The access control unit stores the address as a monitoring target when the flag of the cache line is invalidated.

The multiprocessor control method includes: the access control unit storing a first address included in an invalidated first cache line as a monitoring target; the second processor requesting second data by specifying a second address; the third processor outputting the second address and the second data to the shared bus in response to the request of the second processor; the access control unit receiving the second address and the second data through the shared bus; the access control unit judging whether or not the first address coincides with the second address; and the access control unit relating the first address to the second address to store them when the first address coincides with the second address.

A processor of the present invention includes: an access control unit configured to receive an address and data stored in a main memory device through a shared bus; and a cache memory unit configured to store a cache line including the address, the data and a flag indicating valid or invalid. The cache memory unit invalidates the flag when receiving a request for invalidating the cache line through the shared bus. The access control unit stores the address as a monitoring target when the flag of the cache line is invalidated.

In the situation that the access control unit stores a first address included in an invalidated first cache line as a monitoring target, when the access control unit receives a second address and second data outputted by a third processor connected to the shard bus to the shared bus in response to a request of a second processor connected to the shared bus, the access control unit judges whether or not the first address coincides with the second address and relates the first address to the second address to store them when the first address coincides with the second address.

The multiprocessor system of the present invention can suppress the increase of the waiting time for the shared bus and suppress the deterioration of the performance even in the case that the plurality of threads simultaneously executes the processing for acquiring the right of entry to the critical section.

### BRIEF DESCRIPTION OF DRAWINGS

The above and other objects, advantages and features of the present invention will be more apparent from the following description of exemplary embodiments taken in conjunction with the accompanying drawings.

FIG. 1 is a view showing an initial state of a multiprocessor system;

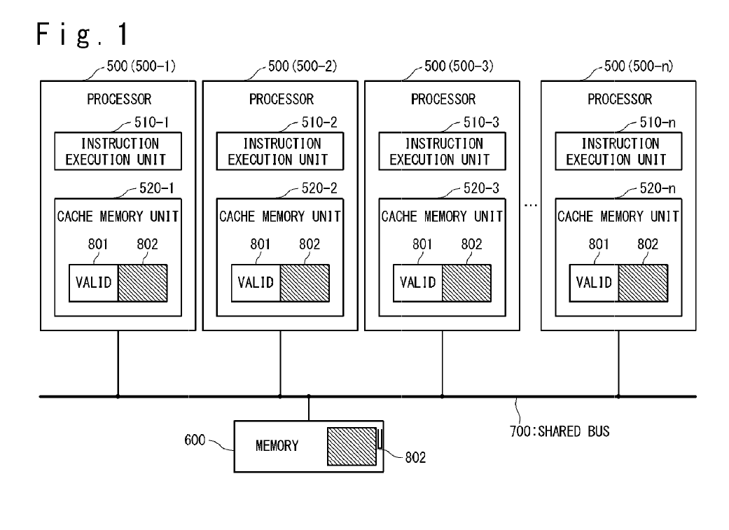

FIG. 2 is a view showing a state that a processor 500-1 starts changing a lock word 802;

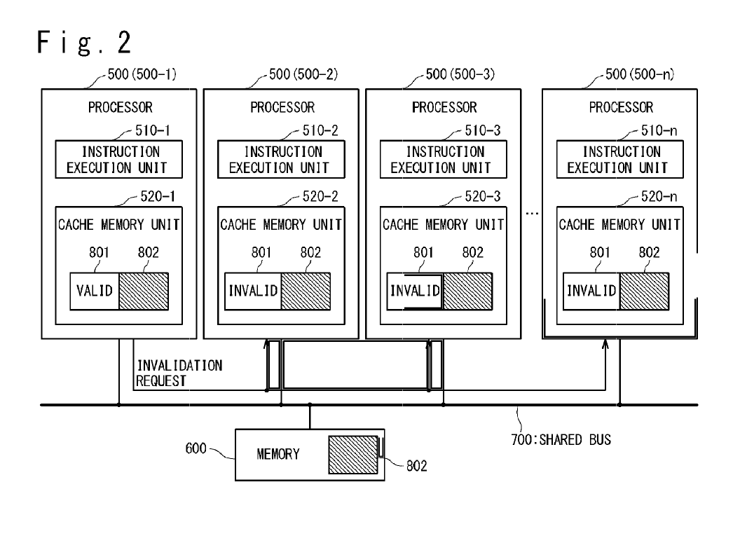

FIG. 3 is a view showing a state that an instruction execution unit 510-1 of the processor 500-1 changes a value of the lock word 802;

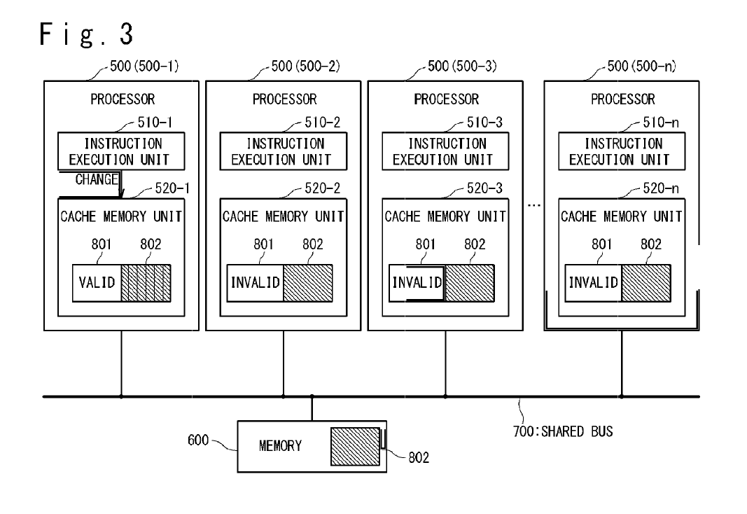

FIG. 4 is a view showing that each of instruction execution units 510-2 to 510-n outputs an access request of each lock word 802;

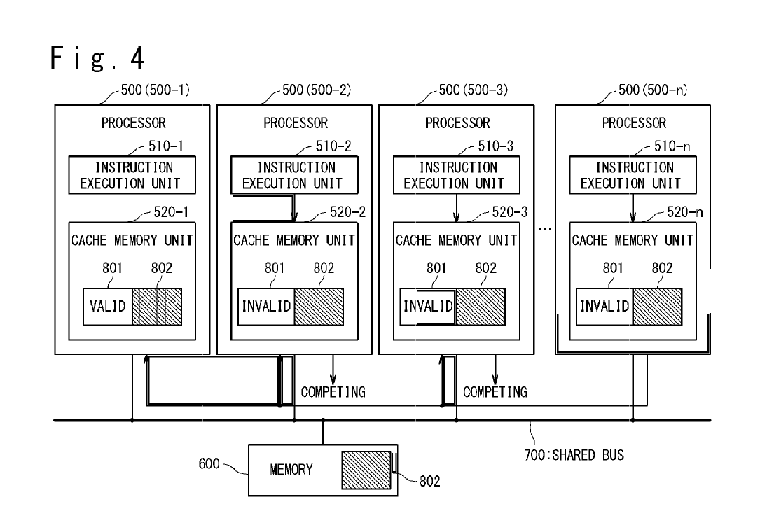

FIG. 5 is a view showing that the processor 500-1 outputs the lock word 802;

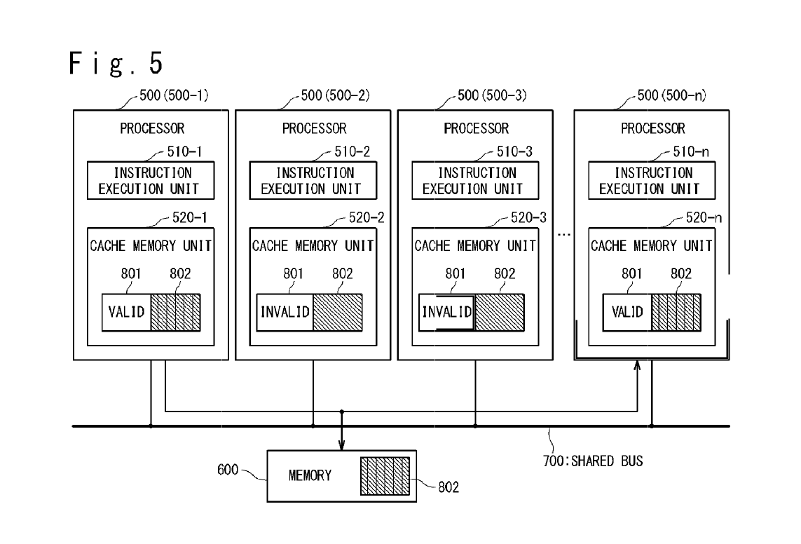

FIG. 6 is a view showing a state after the processor 500-2 outputs the access request to a shared bus 700;

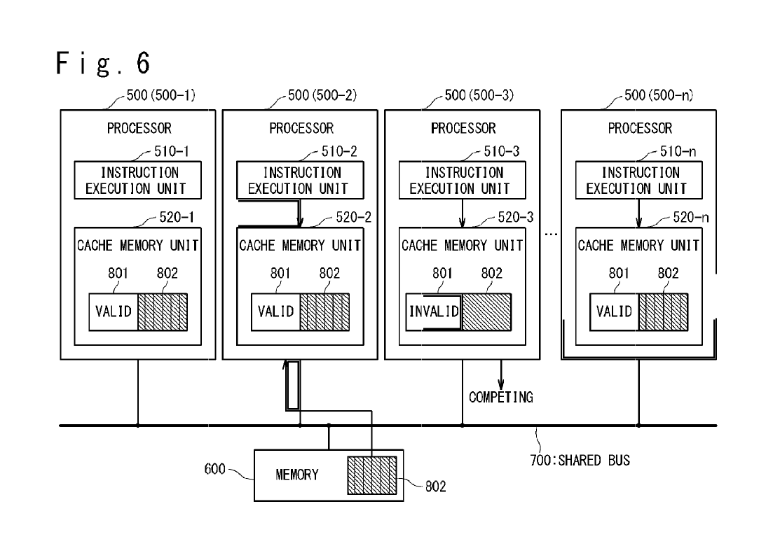

FIG. 7 is a block diagram showing a configuration of a multiprocessor system of the present invention;

FIG. 8 is a view showing an initial state of the multiprocessor system 1 of the present invention;

FIG. 9 is a view showing that each of processors 10-2 to 10-n executes an invalidation processing;

FIG. 10 is a view showing that an instruction execution unit 11-1 changes data 70;

FIG. 11 is a view showing that the processor 10-n outputs an access request of the data 70 to a shared bus 30;

FIG. 12 is a view showing that shared data monitoring units 14-2 and 14-3 of the processors 10-2 and 10-3 respectively store changed data 70; and

FIG. 13 is a view showing that updated data 70 is provided from the shared data monitoring unit 14-2 to the cache memory unit 12-2 in the processor 10-2.

### DESCRIPTION OF EXEMPLARY EMBODIMENTS

A multiprocessor system according to exemplary embodiments of the present invention will be described below referring to the accompanying drawings.

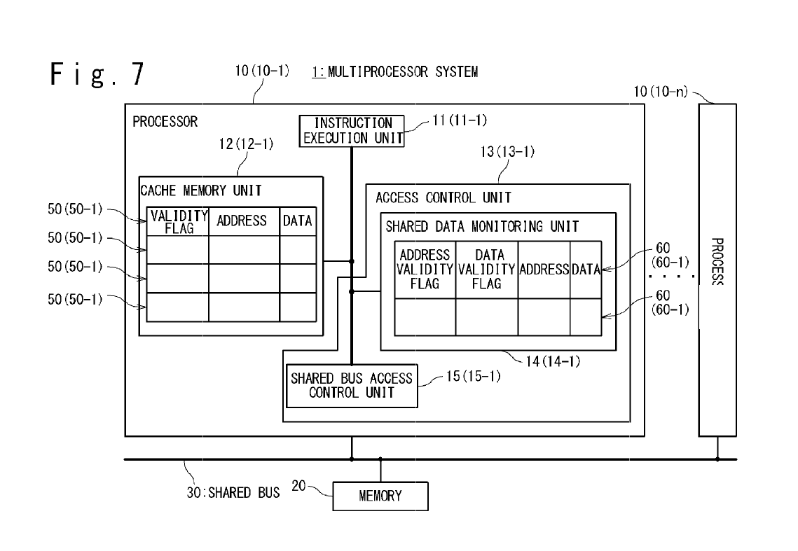

FIG. 7 is a block diagram showing a configuration of the multiprocessor system of the present invention. With reference to FIG. 7, the multiprocessor system 1 of the present invention includes: a plurality of processors 10 (10-1 to 10-n), a memory 20 and a shared bus 30. The plurality of processors 10 (10-1 to 10-n) and the memory 20 are connected to each other through the shared bus 30.

The multiprocessor system 1 according to the exemplary embodiment of the present invention is a main configuration element of a computer system. The processor 10 executes an operational processing and a control processing according to the multiprocessor system 1 of the present invention stored in the memory 20. The memory 20 is a main memory device which records information and stores programs read from a computer-readable recoding medium such as a CD-ROM and a DVD, programs downloaded through a network (not shown), signals and programs inputted from an input device (not shown) and a processing result by the processor 10.

The detail of each of the plurality of processors 10 (10-1 to 10-n) will be described. Here, since each of the plurality of processors 10 (10-1 to 10-n) has the same configuration, the description will be made with reference to the processor 10-1. Here, the processor 10-1 will be called the processor 10 and described. When it is necessary to describe the other processor 10, it will be called the other processor 10 and described. Each part of the processor 10 which will be described can be realized by using any of hardware and software or combination of hardware and software.

The processor 10 includes an instruction execution unit 11, a cache memory unit 12 and an access control unit 13.

The instruction execution unit 11 reads an instruction to be executed and data such as a numeric value necessary to execute the instruction from the memory 20 through the cache memory unit 12 and the access control unit 13. The instruction execution unit 11 executes the instruction by using data included in the cache memory unit 12 (cache line 50).

The cache memory unit 12 stores a plurality of the cache lines 50, each cache line 50 including an address, data and a validity flag. The address indicates an address of the memory 20 and the validity flag indicates valid or invalid of the cache line 50. Here, it is supposed that the cache memory unit 12 of the processor 10 and the cache memory unit of the other processor 10 retain coherency by using the coherence protocol.

When receiving an access request of data specifying an address from the instruction execution unit 11, the cache memory unit 12 judges whether or not the received address exists in the valid cache line 50 with reference to the plurality of cache lines 50. In the case (cache hit) that the address of the data exists in the valid cache line 50, the cache memory unit 12 provides the data to the instruction execution unit 11. On the other hand, in the case (cache miss) that the address of the data does not exist in the valid cache line 50, the cache memory unit 12 provides an access request of the data including the address to the access control unit 13.

Moreover, when receiving a request for invalidating the cache line 50 outputted by the other processor 10 through the shared bus 30, the cache memory unit 12 invalidates the validity flag (invalidation processing). In detail, in the case that an address included in the request for invalidation outputted by the other processor 10 exists in any of the plurality of the cache lines 50, the cache memory unit 12 invalidates the corresponding cache line 50.

The access control unit 13 performs sending and receiving of the address and the data between the memory 20 and the other processor 10 through the shared bus 30. The access control unit 13 includes a shared data monitoring unit 14 and a shared bus access control unit 15.

The shared data monitoring unit 14 includes a plurality of monitoring data 60 as a monitoring target. Each of the plurality of monitoring data 60 includes an address validity flag, a data validity flag, an address and data. When the validity flag of the cache line 50 is invalidated, the shared data monitoring unit 14 stores the address of the invalidated cache line 50 as a monitoring target in the address of the monitoring data 60. In the situation that the shared data monitoring unit 14 stores the address included in the invalidated cache line 50 in the monitoring data 60, when the shared data monitoring unit 14 receives an address and data outputted by still the other processor 10 to the shard bus 30 in response to a request of the other processor 10, the shared data monitoring unit 14 judges whether or not the stored address coincides with the received address. If the stored address coincides with the received address, the shared data monitoring unit 14 relates the stored address to the received data to store them.

When receiving an access request based on the cache miss from the cache memory unit 12, the shared data monitoring unit 14 judges whether or not data which corresponds to an address of the access request and can be provided is stored in the monitoring data 60. If the data is stored, the shared data monitoring unit 14 provides the data related to the address to the instruction execution unit 11 and the cache memory unit 12. If the data is not stored, the shared data monitoring unit 14 provides the access request to the shared bus access control unit 15 in order to output the access request to the shared bus 30. These detailed operations of the shared data monitoring unit 14 will be described later.

When receiving the access request based on the cache miss from the cache memory unit 12, the shared bus access control unit 15 makes the processor 10 continue the processing without outputting the access request to the shared bus 30 when the shared data monitoring unit 14 stores the data which can be provided. On the other hand, the shared bus access control unit 15 outputs the access request to the shared bus 30 when the shared data monitoring unit 14 does not store the data which can be provided.

A processing operation according to the exemplary embodiment of the multiprocessor system 1 of the present invention will be described.

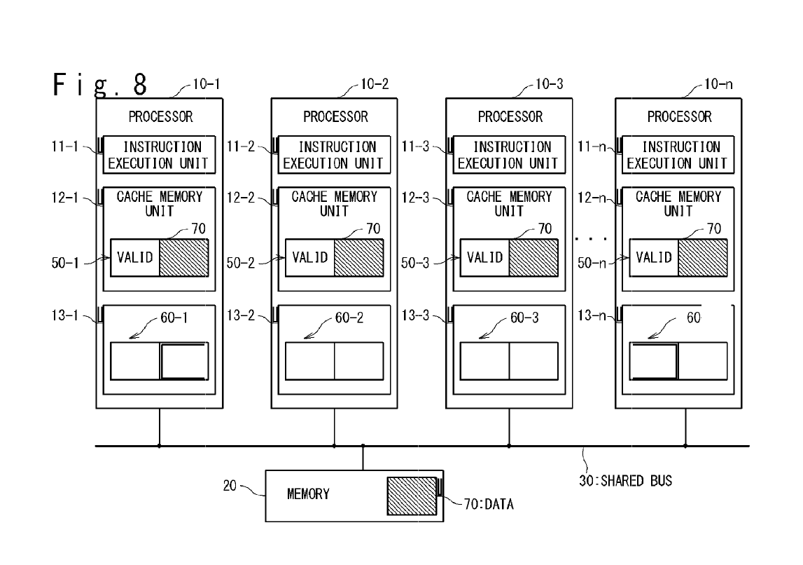

FIG. 8 is a view showing an initial state of the multiprocessor system 1 of the present invention. With reference to FIG. 8, each of the processors 10-1 to 10-n stores copies of data 70 of the memory 20 in each of the cache memory unit 12-1 to 12-n and shares them. Initial values of the data 70 stored in the memory 20 are indicated as diagonal lines. The validity flag of each of the cache lines 50-1 to 50-n including the copies of the data 70 is set to the valid. Here, in FIG. 8, for showing things simply, the address included in the cache lines 50-1 to 50-n, the address included in the monitoring data 60, and the address validity flag included in the monitoring data 60 are omitted. In addition, the shared data monitoring unit 14 and the shared bus access control unit 15 of the access control unit 13 are omitted.

### <Invalidation Request and Data Change of Processer 10-1>

It is supposed that, in the processor 10-1, the instruction execution unit 11-1 needs to do the data writing operation to the memory 20 with the instruction execution, that is, the instruction execution unit 11-1 executes a processing for changing the data 70 stored in the cache memory unit 12-1. First, the instruction execution unit 11-1 executes a processing for invalidating the data 70 stored in each of the processors 10-2 to 10-n. In detail, the instruction execution unit 11-1 specifies an address of the data 70 and provides a request (invalidation request) for invalidating each of the cache lines 50-2 to 50-n including the address to the cache memory unit 12-1.

When receiving the invalidation request from the instruction execution unit 11-1, the cache memory unit 12-1 provides the invalidation request to the shared bus access control unit 15-1. When receiving the invalidation request from the cache memory unit 12-1, the shared bus access control unit 15-1 outputs the invalidation request to the shared bus 30.

In each of the processors 10-2 to 10-n, the corresponding one of the shared bus access control unit 15-2 to 15-n receives the invalidation request outputted from the processor 10-1, and provides it to the corresponding one of the cache memory unit 12-2 to 12-n and the corresponding one of the shared data monitoring unit 14-2 to 14-n. With respect to the invalidation request and the data change of the processor 10-1, since each of the processors 10-2 to 10-n operates similarly to each other, the operation will be described using the processor 10-n as the representative.

In the case that the address included in the invalidation request outputted from the processor 10-1 exists in any of the plurality of cache lines 50-n, the cache memory unit 12-n invalidates the corresponding cache line 50-n (invalidation processing). In detail, the cache memory unit 12-n compares addresses of all of the cache lines 50-n with the received address and judges whether or not the cache line 50-n whose address coincides with the received address exists. If the coincident cache line 50-n exists, the cache memory unit 12-n changes the validity flag of the coincident cache line 50-n into the invalid. However, if a range of the cache lines 50-n to be stored is previously limited based on values of the address, the cache memory unit 12-n may compare only the range of the cache lines 50-n which are possible to coincide with. The cache memory unit 12-n provides a signal (snoop hit signal) indicating that the cache line 50-n is invalidated to the shared data monitoring unit 14-n.

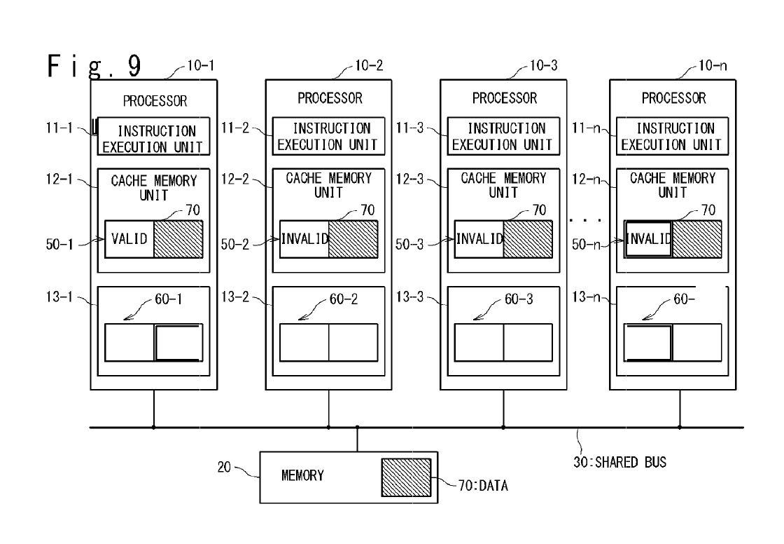

When the cache line 50-n is invalidated, the shared data monitoring unit 14-n monitors the invalidated address such that the data 70 can be received if the data is changed by the other processor 10 (other than the processor 10-n). That is, when the validity flag of the cache line 50-n is invalidated, the shared data monitoring unit 14-n stores the address of the invalidated cache line 50-n as a monitoring target in the address of the monitoring data 60. In detail, in the situation that the shared data monitoring unit 14-n receives the invalidation request from the shared bus access control unit 15-n, when receiving the snoop hit signal from the cache memory unit 12-n, the shared data monitoring unit 14-n sets the address included in the invalidation request to the address of the monitoring data 60-n. Then, the shared data monitoring unit 14-n sets the address validity flag corresponding to the address to the valid. Accordingly, the shared data monitoring unit 14-n operates so as to monitor the address which is invalidated in the cache line 50-n. Here, when the shared data monitoring unit 14-n refers to the monitoring data 60, if the data validity flag of the data 70 corresponding to the address included in the invalidation request is the valid, the shared data monitoring unit 14-n sets the data validity flag of the data 70 to the invalid such that the data 70 is not used. FIG. 9 is a view showing that each of processors 10-2 to 10-n executes the invalidation processing. With reference to FIG. 9, in each of the processors 10-2 to 10-n, in each of the cache lines 50-2 to 50-n including the data 70, the validity flag is set to the invalid. Here, since FIG. 9 is simplified, in each of the monitoring data 60-1 to 60-n, the address of the data 70 and its address validity flag which becomes the valid are omitted.

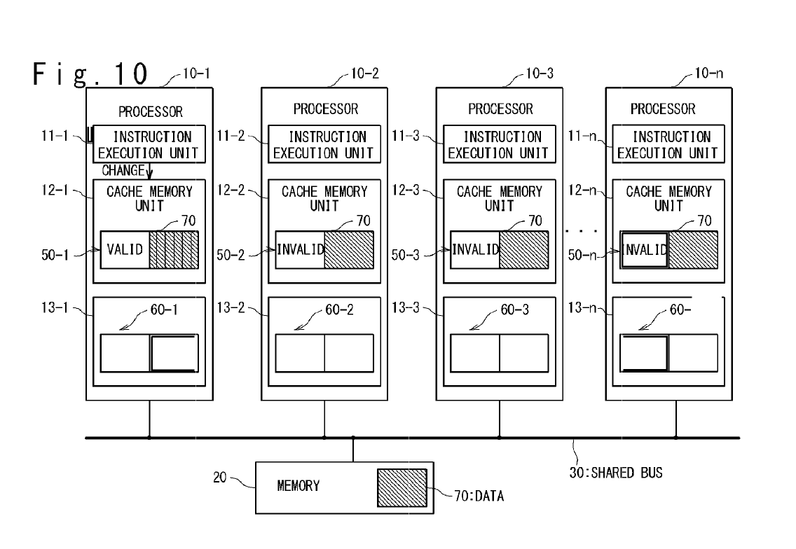

After the processor having the valid cache line 50 (cache line 50 including the validity flag which is set to the valid) including the data 70 becomes the processor 10-1 only, the instruction execution unit 11-1 changes the data 70. FIG. 10 is a view showing that an instruction execution unit 11-1 changes data 70. The changed value of the data 70 is indicated using vertical lines. When the coherence protocol is the copy back policy, the instruction execution unit 11-1 changes the data 70 of the cache memory unit 12-1 only. Therefore, just after the instruction execution unit 11-1 changes the data 70, the value of the data of the memory 20 differs from the value of the data 70 of the processor 10-1. In the case of the writing operation based on the CAS instruction for realizing the mutual exclusion, after the invalidation operation is executed before execution of the CAS instruction, the reading and the writing operations are performed on the data of the cache memory unit 12-1.

<Cache Miss of Processor 10-n>

It is supposed that the processor 10-n needs the data 70. The instruction execution unit 11-n provides an access request for the data 70 to the cache memory unit 12-n, the access request including the address of the data 70.

When receiving the access request for the data 70 from the instruction execution unit 11-n, the cache memory unit 12-n judges whether or not the received address exists in the valid cache line 50-n with reference to the plurality of the cache lines 50-n. If the address of the data 70 exists in the valid cache line 50-n (cache hit), the cache memory unit 12-n provides the data 70 to the instruction execution unit 11-n. On the other hand, if the address of the data 70 does not exist in the valid cache line 50-n (cache miss), the cache memory unit 12-n provides the access request for the data 70 to the shared bus access control unit 15-n and the shared data monitoring unit 14-n.

When receiving the access request based on the cache miss from the cache memory unit 12-n, the shared data monitoring unit 14-n judges whether or not the data 70 which corresponds to the address in the access request and can be provided is stored in the monitoring data 60-n. If the data 70 is stored, the shared data monitoring unit 14-n provides the data 70 related to the address to the instruction execution unit 11-n and the cache memory unit 12-n. If the data is not stored, the shared data monitoring unit 14-n provides the access request to the shared bus access control unit 15-n in order to output the access request to the shared bus 30. In detail, the shared data monitoring unit 14-n performs three judgments: the first one is whether or not the address included in the access request for the data 70 is included in the address of the monitoring data 60-n; the second one is whether or not the address validity flag corresponding to the address is valid; and the third one is whether or not the data validity flag of the data 70 corresponding to the address is valid. If the shared data monitoring unit 14-n judges that the address included in the access request for the data 70 is included in the address of the monitoring data 60-n, the address validity flag corresponding to the address is valid, and the data validity flag of the data 70 corresponding to the address is valid, the shared data monitoring unit 14-n judges that the changed data 70 which can be provided is stored. Then, the shared data monitoring unit 14-n provides the changed data 70 which can be provided to the cache memory unit 12-n and provides a signal (buffer hit signal) indicating that the changed data 70 which can be provided is stored to the shared bus access control unit 15-n.

Incidentally, the operation described here is the case that the processor 10-n needs the data 70 just after the operation of the above-described invalidation request and the data change of the processor 10-1. Thus, here, the changed data 70 which can be provided is not stored. Therefore, the shared data monitoring unit 14-n judges that the changed data 70 which can be provided is not stored and so the shared data monitoring unit 14-n does not provide the buffer hit signal.

When receiving the access request based on the cache miss from the cache memory unit 12-n, if the shared data monitoring unit 14-n stores the data which can be provided, the shared bus access control unit 15-n does not output the access request to the shared bus 30 and retains the processing in the processor 10-n. On the other hand, if the shared data monitoring unit 14-n does not store the data which can be provided, the shared bus access control unit 15-n outputs the access request to the shared bus 30. In detail, in the situation that the shard bus access control unit 15-n receives the access request for the data 70 from the cache memory unit 12-n, when receiving the buffer hit signal from the shared data monitoring unit 14-n, the shared bus access control unit 15-n does not output the access request for the data 70 to the shared bus 30 and retains the processing in the processor 10-n. On the other hand, in the situation that the shard bus access control unit 15-n receives the access request for the data 70 from the cache memory unit 12-n, when not receiving the buffer hit signal from the shared data monitoring unit 14-n, the shared bus access control unit 15-n outputs the access request for the data 70 to the shared bus 30. That is, the shared bus access control unit 15-n acquires the changed data 70 from the plurality of the other processors 10 (other than 10-n) connected to the shared bus 30.

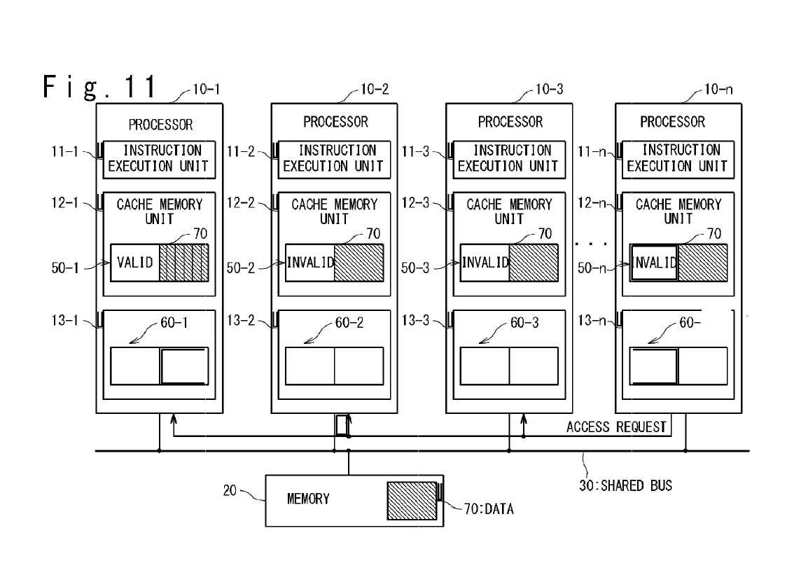

Here, it is supposed that the shared bus access control unit 15-n outputs the access request for the data 70 to the shared bus 30. FIG. 11 is a view showing that the processor 10-n outputs the access request of the data 70 to the shared bus 30.

<Response to Access Request from Processor 10-n>

In each of the plurality of the processors 10 except the processor 10-n, each shared bus access control unit 15 (other than 15-n) receives the access request for the data 70 and provides it to each cache memory unit 12 (other than 12-n) and each shared data monitoring unit 14 (other than 14-n). Here, since the processor 10-1 stores the updated data 70, the processor 10-1 outputs a response of the data 70 to the shared bus 30, the response including the changed data 70 and its address.

The operation at that time of the processor 10-1 will be described. The shared bus access control unit 15-1 provides the address included in the access request for the data 70 to the cache memory unit 12-1. The cache memory unit 12-1 judges whether or not the valid cache line 50-1 including the changed data 70 exists. The cache memory unit 12-1 judges the valid cache line 50-1 including the changed data 70 exists and provides the changed data 70 to the shared bus access control unit 15-1. The shared bus access control unit 15-1 outputs the response of the data 70 to the shared bus 30.

The operation of the other processors 10 (10-2 to 10-n-1) except the processors 10-1 and 10-n will be described. With respect to the response to the access request from the processor 10-n, since each of the processors 10-2 to 10-n-1 operates similarly to each other, the operation will be described using the processor 10-2 as the representative. The shared bus access control unit 15-2 provides the address included in the access request of the data 70 to the cache memory unit 12-2. The cache memory unit 12-2 judges whether or not the valid cache line 50-2 including the changed data 70 exists. The cache memory unit 12-2 judges that the valid cache line 50-2 including the changed data 70 does not exist and does not provide the response of the data 70 to the shared bus access control unit 15-2.

<Response Processing of Processor 10-n>

The shared bus access control unit 15-n of the processor 10-n acquires the response of the data 70. The shared bus access control unit 15-n provides the response of the data 70 to the cache memory unit 12-n and the instruction execution unit 11-n. The cache memory unit 12-n stores the address and the changed data 70 included in the response of the data 70 in the cache line 50-n and sets the validity flag of the cache line 50-n to the valid. In addition, the instruction execution unit 11-n continues the execution of the instruction.

<Response Processing of Processors 10-2 to 10-n-1>

On the other hand, in each of the processors 10-2 to 10-n-1, as described in the invalidation request of the processor 10-1, each of the cache lines 50-2 to 50-n-1 is invalidated and the invalidated address is monitored such that the data 70 changed at the other processor 10 can be received. With respect to the response processing of the processors 10-2 to 10-n-1, since each of the processors 10-2 to 10-n-1 operates similarly to each other, the operation will be described using the processor 10-2 as the representative.

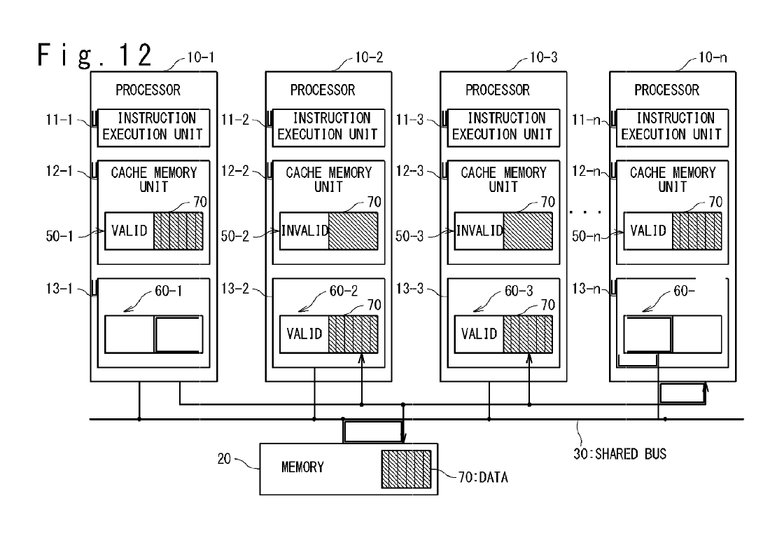

The shared bus access control unit 15-2 of the processor 10-2 receives the response of the data 70. The shared bus access control unit 15-2 provides the response of the data 70 to the shared data monitoring unit 14-2. The shared data monitoring unit 14-2 judges whether or not the response of the data 70 is the monitoring target. That is, in the situation that the shared data monitoring unit 14-2 stores the address included in the invalidated cache line 50-2 in the monitoring data 60-2, when receiving the address and the data outputted by the processor 10-1 to the shared bus 30 in response to the request of the processor 10-n, the shared data monitoring unit 14-2 judges whether or not the stored address coincides with the received address. If the stored address coincides with the received address, the shared data monitoring unit 14-2 relates the stored address and the received address and stored the address and the data. In detail, the shared data monitoring unit 14-2 judges whether or not the address included in the response of the data 70 coincides with the address set to the address of the monitoring data 60-2 and whether or not the address validity flag corresponding to the address is valid. If the response of the data 70 is the monitoring target, the shared data monitoring unit 14-2 stores the changed data 70 in the monitoring data 60-2 and sets the data validity flag corresponding to the changed data 70 to valid. FIG. 12 is a view showing that each of the shared data monitoring units 14-2 to 14-n-1 stores the changed data 70 in each of the processors 10-2 to 10-n-1.

At this time, the memory 20 acquires the changed data 70 from the shared bus 30.

### <Cache Miss of Processor 10-2>

Here, it is assumed that the processor 10-2 needs the data 70. The instruction execution unit 11-2 provides the access request for the data 70 including the address of the data 70 to the cache memory unit 12-2.

When receiving the access request for the data 70 from the instruction execution unit 11-2, with reference to the plurality of the cache lines 50-2, the cache memory unit 12-2 judges whether or not the received address exists in any of the valid cache lines 50-2. However, the address of the data 70 does not exist in the valid cache lines 50-2 (cache miss), the cache memory unit 12-2 provides the access request of the data 70 to the shared data monitoring unit 14-2 and the shared bus access control unit 15-2.

When receiving the access request for the data 70 from the cache memory unit 12-2, with reference to the monitoring data 60-2, the shared data monitoring unit 14-2 judges whether or not the changed data 70 which can be provided is stored. In detail, the shared data monitoring unit 14-2 performs three judgments: the first one is whether or not the address included in the access request for the data 70 is included in the address of the monitoring data 60-2; the second one is whether or not the address validity flag corresponding to the address is valid; and the third one is whether or not the data validity flag of the data 70 corresponding to the address is valid. The shared data monitoring unit 14-2 judges that the address included in the access request for the data 70 is included in the address of the monitoring data 60-2, the address validity flag corresponding to the address is valid, and the data validity flag of the data 70 corresponding to the address is valid. That is, the shared data monitoring unit 14-2 judges that the changed data 70 which can be provided is stored. Then, the shared data monitoring unit 14-2 provides the changed data 70 which can be provided to the cache memory unit 12-2 and further provides the signal (buffer hit signal) indicating that the changed data 70 which can be provided is stored to the shared bus access control unit 15-2.

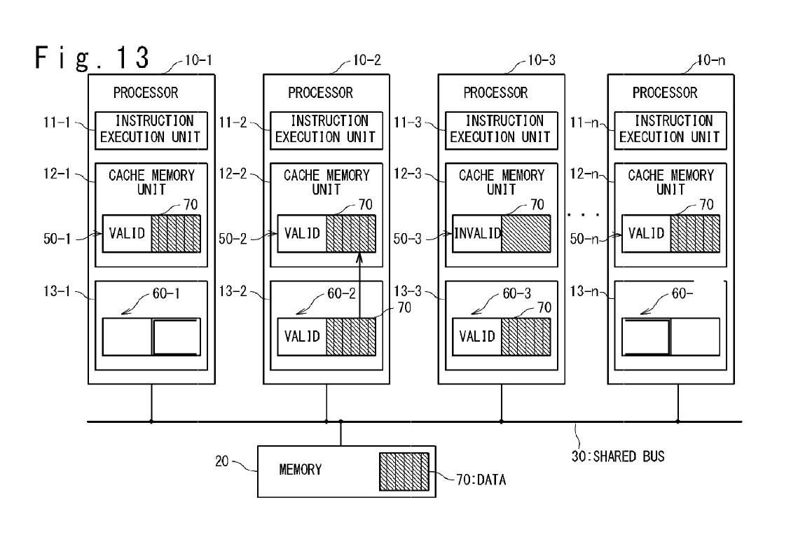

The shared bus access control unit 15-2 receives the buffer hit signal from the shared data monitoring unit 14-2 in the situation that the shared bus access control unit 15-2 receives the access request for the data 70 from the cache memory unit 12-2. Therefore, the shared bus access control unit 15-2 does not output the access request for the data 70 to the shared bus 30 and the processing in the processor 10-2 continues. FIG. 13 is a view showing that the updated data 70 is provided from the shared data monitoring unit 14-2 to the cache memory unit 12-2 in the processor 10-2.

Even in the case that the processors 10-3 to 10-n-1 need the data 70, the processors 10-3 to 10-n-1 operate similarly to the processor 10-2. That is, even in the case that the plurality of processors 10 (10-2 to 10-n-1) executes the processing for acquiring the right of entry simultaneously, the effect that the waiting time of the shared bus can be suppressed can be obtained.

As described above, the multiprocessor system 1 of the present invention can suppress the increase of the waiting time of the shared bus 30 even in the situation that the plurality of threads simultaneously executes the processing for acquiring the right of entry to the critical section. That is, since the multiprocessor system 1 of the present invention operates such that the access to the data which manages the situation of the critical section through the shared bus is not concentrated, the program performance can be improved.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

This application is based upon and claims the benefit of priority from Japanese patent application No. 2011-008120 filed on Jan. 18, 2011, the disclosure of which is incorporated herein in its entirety by reference.

1. A multiprocessor system comprising:
a first processor;
a second processor;
a third processor;
a main memory device configured to store data related to an address; and
a shared bus configured to connect the first processor, the second processor, the third processor and the main memory device,
wherein the first processor includes:
an access control unit configured to receive the address and the data through the shared bus, and
a cache memory unit configured to store a cache line including the address, the data and a flag indicating valid or invalid,
wherein the cache memory unit invalidates the flag when receiving a request for invalidating the cache line through the shared bus,
the access control unit stores the address as a monitoring target when the flag of the cache line is invalidated, and
in the situation that the access control unit stores a first address included in an invalidated first cache line as a monitoring target, when the access control unit receives a second address and second data outputted by the third processor to the shared bus in response to a request of the second processor, the access control unit judges whether or not the first address coincides with the second address and relates the first address to the second address to store them when the first address coincides with the second address.

2. The multiprocessor system according to claim 1, wherein the first processor further includes:
an instruction executing unit configured to execute an instruction by using the data included in the cache line,
wherein when the instruction execution unit requests a first data included in the first cache line by specifying the first address,
the cache memory unit provides the first address to the access control unit based on the first cache line having been invalidated, and
the access control unit provides the second data related to the first address to the instruction execution unit and the cache memory unit.

3. A multiprocessor control method of a multiprocessor system, wherein the multiprocessor comprises:
a first processor,
a second processor,
a third processor,
a main memory device configured to store data related to an address, and
a shared bus configured to connect the first processor, the second processor, the third processor and the main memory device,
wherein the first processor includes:
an access control unit configured to receive the address and the data through the shared bus,
a cache memory unit configured to store a cache line including the address, the data and a flag indicating valid or invalid, and
an instruction executing unit configured to execute an instruction by using the data included in the cache line,
wherein the cache memory unit invalidates the flag when receiving a request for invalidating the cache line through the shared bus, and
the access control unit stores the address as a monitoring target when the flag of the cache line is invalidated,
the multiprocessor control method comprising:
the access control unit storing a first address included in an invalidated first cache line as a monitoring target;
the second processor requesting second data by specifying a second address;
the third processor outputting the second address and the second data to the shared bus in response to the request of the second processor;
the access control unit receiving the second address and the second data through the shared bus;
the access control unit judging whether or not the first address coincides with the second address; and
the access control unit relating the first address to the second address to store them when the first address coincides with the second address.

4. The multiprocessor control method according to claim 3, further comprising:
the instruction execution unit requesting a first data included in the first cache line by specifying the first address;
the cache memory unit providing the first address to the access control unit based on the first cache line having been invalidated; and
the access control unit providing the second data related to the first address to the instruction execution unit and the cache memory unit.

5. A processor comprising:
an access control unit configured to receive an address and data stored in a main memory device through a shared bus; and
a cache memory unit configured to store a cache line including the address, the data and a flag indicating valid or invalid,
wherein the cache memory unit invalidates the flag when receiving a request for invalidating the cache line through the shared bus,
the access control unit stores the address as a monitoring target when the flag of the cache line is invalidated, and
in the situation that the access control unit stores a first address included in an invalidated first cache line as a monitoring target, when the access control unit receives a second address and second data outputted by a third processor connected to the shard bus to the shared bus in response to a request of a second processor connected to the shared bus, the access control unit judges whether or not the first address coincides with the second address and relates the first address to the second address to store them when the first address coincides with the second address.

6. The processor according to claim 5, further comprising:
an instruction executing unit configured to execute an instruction by using the data included in the cache line,
wherein when the instruction execution unit requests a first data included in the first cache line by specifying the first address,
the cache memory unit provides the first address to the access control unit based on the first cache line having been invalidated, and
the access control unit provides the second data related to the first address to the instruction execution unit and the cache memory unit.
